(19) United States
(12) Patent Application Publication
(10) Pub. No.: US 2002/0198699 A1
(43) Pub. Date: Dec. 26, 2002

(54) Apparatus, system and method for providing open source language translation

(75) Inventors: David Perry Greene, Ossining, NY (US); Edith Helen Stern, Yorktown Heights, NY (US); Barry Edward Willner, Briarcliff Manor, NY (US); Philip Shi-Lung Yu, Chappagua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/886,867

(22) Filed: Jun. 21, 2001

(51) Int. Cl. G06F 17/28

(52) U.S. Cl. 704/2

(57) ABSTRACT

An apparatus, system and method for providing open source translations of media via a data network are provided. With the apparatus, system and method, users may upload translations of media to a server which then makes these translations available to other users for download. The uploading of the translation may be in the form of a complete file or may be performed in realtime while the user is receiving the media at his/her client device. The apparatus, system and method further provide a mechanism by which a submitter of the translation may be compensated based on the number of times the translation is downloaded. In addition, the apparatus, system and method provide a mechanism by which a translation may be converted from one format to another, such as from an audio format to a text format. Moreover, the apparatus, system and method provide a mechanism by which feedback regarding the quality of the translations may be provided by users to thereby adjust a quality ranking of the translation and determine whether to keep providing the translation to other users.

### BACKGROUND OF THE INVENTION

1. Technical Field

The present invention is directed to an improved data processing system. More specifically, the present invention is directed to an apparatus, system and method for providing open source language translation.

2. Description of Related Art

One of the great contributions of the Internet is to break the geographic limitations of the distribution of mass media. Today, typically a radio or television broadcaster is limited to a geographic region by government regulation and limitations of its over the air, cable or even satellite transmission system. On the Internet, however, media is transmitted world wide without regulation. Thus, there is no longer a need to have a critical mass of media consumers within a geographic region. Media can be produced for worldwide consumption.

However, for media to be effective worldwide, especially when consumed as part of every day life, it must be translated into the local languages of the consumers. While the business or multilingual elite may be willing to use programming totally in English, this would not be acceptable to masses of people who speak a wide variety of languages.

Today, first rate Hollywood entertainment, best selling books, leading technical and scientific publications, and the like are translated into a variety of languages. This is done at high quality and considerable expense, proportionate to the high economic value of these items. However, the public must wait until the publishers of this media are ready and able to distribute the media in a plurality of different languages. Even then, the publishers may only publish the media in a small number of languages and not provide the media in a language that is useful to certain people.

Moreover, not all media may be made available to the public in different languages. Typically, only media that is published by professional publishers will be made available in a number of different languages. Such publishers include well known movie companies, book publishing companies, and the like. Media generated by nonprofessionals is rarely translated into other languages. Such media, such as an amateur film or book, may be of interest to a larger audience but may not made available to this larger audience due to the expense necessary to translate the media into other languages. Thus, it would be beneficial to have an apparatus, system and method in which translations of media are made available to masses of people in a low cost manner. Furthermore, it would be beneficial to have an apparatus, system and method in which the people themselves may offer translations of the media rather than waiting for a publisher of the media to release a version in a different language.

### SUMMARY OF THE INVENTION

The present invention provides an apparatus, system and method for providing open source translations of media via a data network. With the present invention, users may upload translations of media to a server which then makes these translations available to other users for download. The uploading of the translation may be in the form of a complete file or may be performed in realtime while the user is receiving the media at his/her client device. The present invention further provides a mechanism by which a submitter of the translation may be compensated based on the number of times the translation is downloaded. In addition, the present invention provides a mechanism by which a translation may be converted from one format to another, such as from an audio format to a text format. Moreover, the present invention provides a mechanism by which feedback regarding the quality of the translations may be provided by users to thereby adjust a quality ranking of the translation and determine whether to keep providing the translation to other users.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a network data processing system in which the present invention may be implemented;

FIG. 2 is an exemplary block diagram of a server in accordance with the present invention;

FIG. 3 is an exemplary block diagram of a client device in accordance with the present invention;

FIG. 4 is a general block diagram illustrating the primary operational components of the present invention;

FIG. 5 is an exemplary diagram of an interface for selecting media and corresponding translations in accordance with the present invention;

FIG. 6 is an exemplary diagram illustrating an interface through which media and translations may be received and feedback may be submitted in accordance with the present invention; and

FIG. 7 is a flowchart outlining an exemplary operation of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

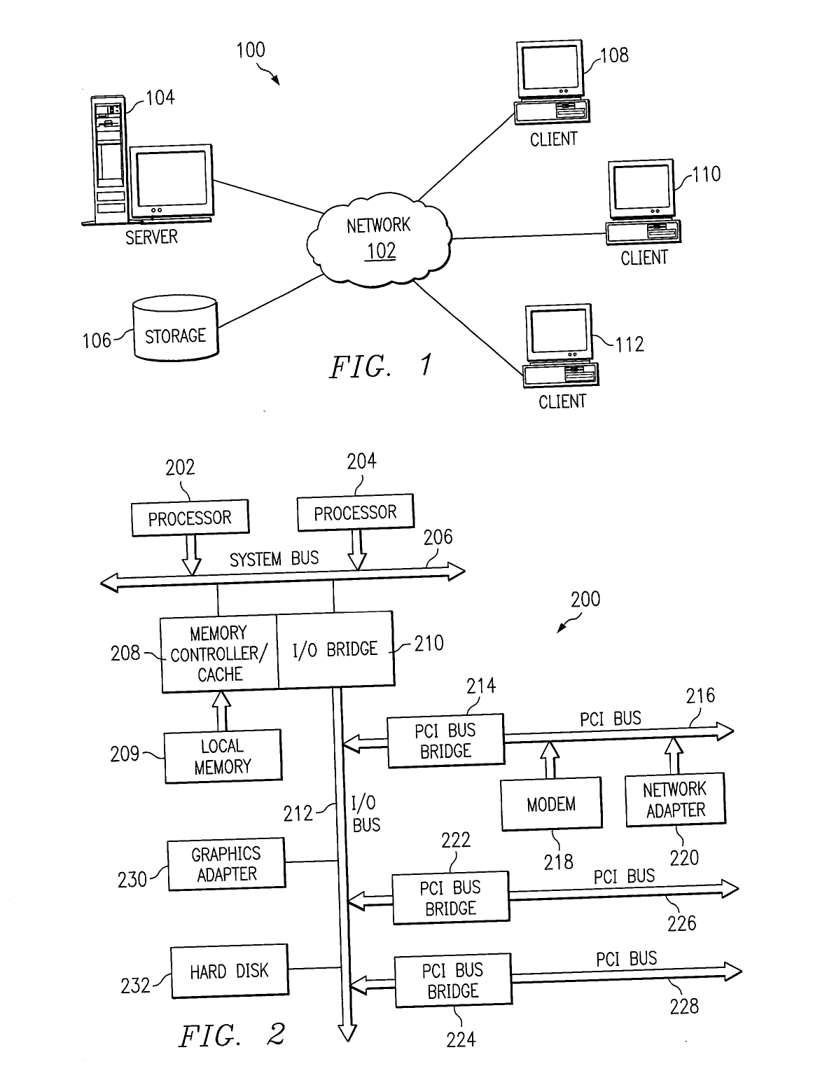

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

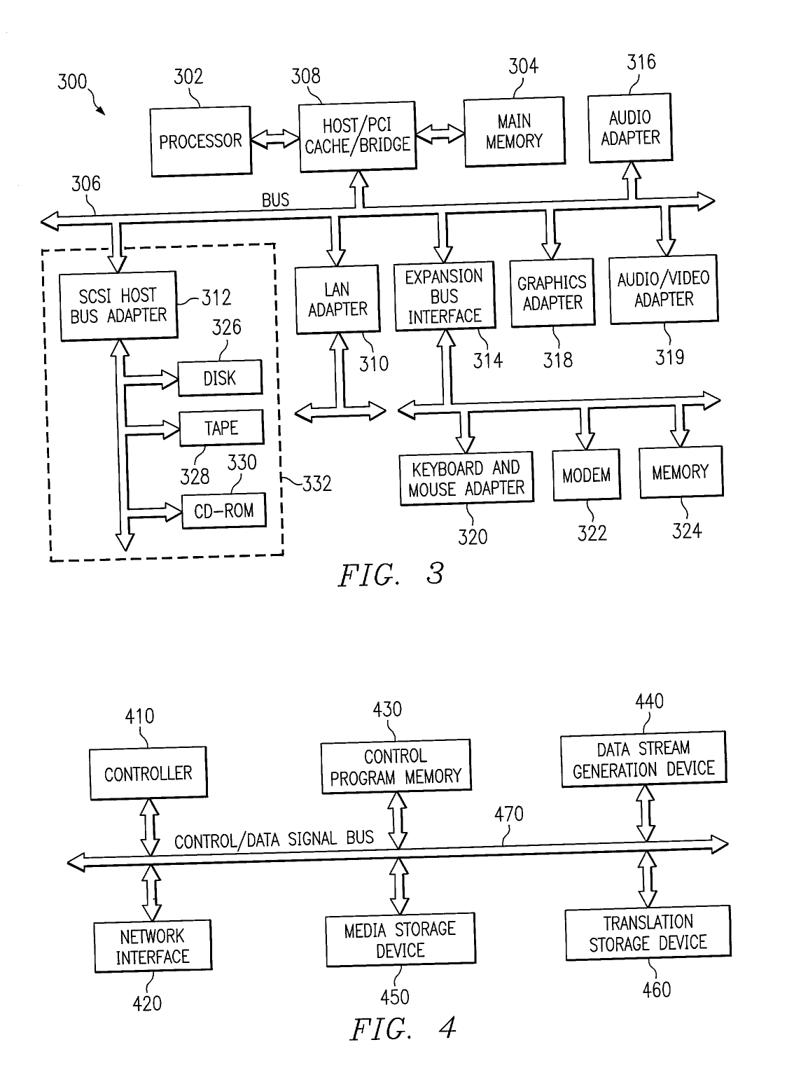

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used.

Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With the present invention, media is made available to masses of users via a data network, such as the Internet. The media further has associated translations which may be generated by the publishers of the media and/or individual users that choose to upload translations to the server on which the media is made available. The present invention further enables users to download written translations of media if such written translations are available, and upload their own written translations to the server. In short, the present invention provides a mechanism for facilitating open source translations of media made available over a data network.

In addition to the above, the present invention provides a mechanism by which users may provide feedback regarding the quality and accuracy of the various translations available for the media. Based on the feedback received, the ranking of the translations may be adjusted. If the ranking of a translation falls below a threshold, the translation may be removed from availability and future uploads of translations from the submitter of the translation may be blocked. Rather than blocking the download, however, a ranking of the translation may be displayed to guide potental users of the translation in their choices as to which translations to use.

Referring again to FIG. 1, with the present invention a user of a client device, such as client device 110, may log onto server 104 that provides media for download or streaming to the client device 110. The user of the client device may select a media file for download or streaming and an associated translation of the media. Once selected, the present invention transmits the media and the translation to the client device.

In a preferred embodiment, the transmission of the media involves data streaming, which is generally known in the art. With the present invention, however, the data streaming may involve two streams, one for the media and one for the translation. The translation may be audio or text. Whether audio or text, the present invention synchronizes the two streams so that the events occurring in the media correspond to the translation. Such synchronization may be performed in any of a plurality of different ways, including using markers, such as timestamps, in the media and the translation for matching up portions of the two data streams, for example. In other preferred embodiments, the translation is incorporated into the media at the server and a single stream is made available to the user.

For example, the media may comprise a plurality of tracks, e.g., 24 tracks. The tracks may include one or more music tracks, speech tracks, special effects tracks, and the like. Rather than providing two data streams, there may be additional processing which replaces one or more of these tracks with a translation track and remixes the media tracks. For example, the speech track may simply be replaced with the new translation track, and the media remixed. This processing assumes the availability of the original individual tracks to simplify the remixing. For written translations, which will be discussed in greater detail hereafter, the text may be presented as closed captioning, for example. This may require mixing in the digital domain or potentially adding the captioning in the analog domain and redigitizing. By adding in the translation as one of the tracks of the media and then remixing the media, a single data stream may be provided to the client device rather than having multiple data streams and having to correlate the two.

The translations provided by the present invention may be generated by a publisher of the media and/or users of the present invention. For example, if a user determines that the present invention does not have a translation of a media in a particular language of interest, the user may take it upon himself/herself to provide this translation. In so doing, the user may download or stream the media to his/her client device and generate a translation which he/she may then upload to the server of the present invention. Alternatively, the user may upload the translation on a realtime basis as the user is receiving the data stream of the media from the server of the present invention. The user may enter the translation by way of speaking into a microphone or typing the translation using a keyboard associated with his/her client device.

Whether the translation is uploaded as a complete file or is uploaded on a realtime basis during the streaming of the media to the client device, the resultant translation file may be stored on the server of the present invention for later use by other users. When storing the translation, the server may update its registry of available translations and provide an option to use the new translation to subsequent users.

In addition to receiving the translation from the user, the present invention may compile information about the user-translator for use in managing the translations offered by the present invention. For example, the present invention may require that the user-translator submit his/her name, address, electronic mail address, translator identification, translator education level, level of expertise in the language of the translation, a description of the translation, a parental guidance rating of the translation (such as PG, PG-13, R), and the like. This information may be used to correlate other translations provided by the same user-translator as well as limit the user-translators from which translations may be uploaded. This information, or portions thereof, may further be provided as metadata regarding the translation that may be viewable by users during their selection of a translation for download.

As a further feature of the present invention, a record may be maintained regarding how many times a translation is downloaded from the server. This record or number of downloads may be used as a basis for compensating the user-translator for providing the translation, for example. The present invention may further include a payment system that is capable of electronically transferring monetary amounts to a user-translator's account based on the number of times the user-translator's translations are downloaded from the server. Rather than payment being based solely on the number of times the translation is downloaded, the payment system of the present invention may be based on any payment scheme deemed appropriate. For example, the payment scheme may be a flat fee payment for any accepted translation, may be based on the length of the media translated, may be based on the importance of the media translated, may include offering a bounty on important media or difficult-to-obtain language translations, and the like. For purposes of discussion, however, it will be assumed that the payment scheme is based on a number of times the translation is downloaded to client devices.

As mentioned above, the present invention may compile information about users that submit translations for use by the present invention. The present invention may make use of this information to determine whether to accept the translation for use. For example, the present invention may accept translations only from authorized translators. The present invention may authorize users as translators, for example, based on their education levels, expertise in the designated language, and the like. Thereafter, when a user wishes to offer a translation of a piece of media, the user may enter his/her translator authorization identification in order to have the present invention accept the translation.

In addition, as mentioned above, the present invention is capable of providing both audio and textual translations of pieces of media. In one embodiment, the users or authorized translators, provide the audio and/or textual translations directly to the server of the present invention. Alternatively, the present invention may generate audio or textual translations from other versions of the translations. For example, if a user provides an audio translation of a piece of media, the present invention may make use of a voice recognition program for generating a textual version of the translation. Similarly, the present invention may use a voice synthesis device for generating an audio version of a text translation provided by a user. These alternative versions may be stored by the server of the present invention in association with the piece of media and provided to subsequent users for download.

In order to make sure that the quality of the translations provided is maintained at a high level, the present invention may prompt users that download a translation for feedback on the quality of the translation. Such feedback may be a free form type of feedback allowing the users to input any comments they wish to provide, or may be a fixed form type of feedback asking the user to input selections of “rankings” of various aspects of the translations. The feedback received may be logged by the server of the present invention and used to adjust a quality ranking of the translation. If the quality ranking of the translation drops below a predetermined threshold, the present invention may remove the translation from the listing of available translations and, in the more severe cases, prohibit a user that submitted the translation from uploading further translations.

Thus, the present invention provides a mechanism by which users may upload translations of media available by the server of the present invention. These translations may then be provided to other users for download. In this way, the cost of generating translations is reduced by having users voluntarily provide the translations and/or compensate the users for use of the translations based on the number of times the translation is downloaded.

FIG. 4 is an exemplary block diagram of the primary operational elements of the present invention. The elements shown in FIG. 4 may be implemented in software, hardware or a combination of software and hardware. In a preferred embodiment, the elements in FIG. 4 are implemented as a combination of hardware and software. For example, the controller 410 may be a processor, such as processor 202 or 204, that operates based on software instructions to thereby perform the functions of the present invention. The data stream generation device 440 may be implemented as software instructions executed on a processor as well. The other elements 420, 430, 450 and 460 may be implemented as hardware elements operating based on operational programs as is generally known in the art.

As shown in FIG. 4, the primary operational elements of the present invention include a controller 410, a network interface 420, a control program memory 430, a data stream generation device 440, a media storage device 450, and a translation storage device 460. These elements 410-460 are coupled to one another via the control/data signal bus 470. Although a bus architecture is shown in FIG. 4, the present invention is not limited to such and any architecture that facilitates the exchange of control and data signals between the elements 410-460 may be used without departing from the spirit and scope of the present invention.

In addition, while FIG. 4 shows the media storage device 450 and the translation storage device 460 as being co-located with the other elements of the present invention, this is not necessarily required. Rather, the media storage device 450 and the translation storage device 460 may be located remotely from the other elements of the present invention and may further be distributed across a plurality of devices in the data network 102. The media storage device 450 and translation storage device 460 are shown as being co-located only for simplicity and to aide in the following explanation of the functioning of the present invention.

The controller 410 controls the overall operation of the present invention and orchestrates the operation of the other elements 420-460 based on control program(s) stored in the control program memory 430. The controller 410 receives requests for media from client devices via the network interface 420. In response to receiving the request for media, the controller 410 retrieves a listing of available media from the media storage device 450 and corresponding translations from the translation storage device 460. The controller 410 then provides the listing to the client device in the form of a web page, applet, or the like.

The user of the client device may then select, using the web page, applet, or the like, a media and corresponding translation for download. Alternatively, the user of the client device may select an option for uploading a new translation, or may select both options. The user-translator may choose to translate one of the previous translations. In this manner, for example, a movie may be translated first to Mandarin, and then to another dialect of Chinese by someone who speaks Mandarin and the desired dialect. The user's selections are then transmitted to the controller 410 via the data network and network interface 420. Based on the selections of the user, the controller 410 performs corresponding functions.

For example, if the user selected a media and corresponding translation, the controller 410 instructs the data stream generation device 440 to retrieve the selected media and translation and generate one or more data streams based on the retrieved media and translation. The data stream(s) may be synchronized by the data stream generation device 440 so that the translation maps to the media appropriately. As mentioned above, such synchronization may be based on markers in the media and translation, such as a timestamp or the like.

In some embodiments the synchronization is exact, while in others it is approximate. If the synchronization is performed by the server, the synchronization may be exact when using audio translation and approximate when using written translation. Moreover, if the synchronization is done at the client device, it will most likely be approximate because exact synchronization requires special hardware that may not be available to all client devices. However, as mentioned above, rather than using multiple data streams, the present invention supports use of remixed media, and delivery of a single stream. Thereby, an exact synchronization is obtained at the server prior to download to the client device.

After the media and translation are provided to the client device, the user of the client device may be prompted to submit feedback regarding the media and translation. This feedback information may then be used by the controller 410 to update a quality rating of the translation in the translation storage device 460. The controller 410 may then compare the translation's quality rating to a predetermined threshold to determine if the translation has such a low quality so as to warrant removal of the translation from the available translations. If so, the translation may be removed from the listing of available translations and may even be deleted from the translation storage device 450.

In addition, the controller 410 may store in memory a listing of translation suppliers that should be blocked from submitting further translations. The user that supplied the translation may be added to the list of translation suppliers that should be blocked in the event that the translation quality rating falls below the predetermined threshold.

If a user selected to upload a new translation to the server of the present invention, the controller 410 may prompt the user to designate the file to be uploaded and the corresponding media to which it belongs. The user may then designate the file and begin the upload process. Alternatively, if a new translation is to be uploaded in realtime, the controller 410 may stream the media to the user's client device and receive corresponding translation information via the network interface 420. The translation information may be matched to the media by way of timestamp information indicating an elapsed time from the beginning of the media, by SMPTE time codes, etc. The controller 410 may store this translation information in the translation storage device 460 and update a translation registration stored in memory, such as control program memory 420 or translation storage device 460. Alternatively, rather than storing the translation separately, the present invention may replace one or more tracks in the media with the uploaded translation and remix the media. This remixed media may then be stored as an alternative version of the media in the translation storage device 460, for example.

As mentioned above, the present invention may further store information regarding how many times a translation is downloaded to a client device. This information may be stored in a data structure associated with the translation in the translation storage device 460. This information may be used to generate a compensation amount for the submitter of the translation. The controller 410 may, based on this information, instruct a billing and payment system (not shown) to transfer monetary units to an account of the submitter of the translation.

Also, as previously mentioned, the controller 410, after having received a translation in a particular format, may generate corresponding translations in other formats. For example, the controller 410 may make use of a voice recognition system (not shown) to convert an audio translation into a textual translation. Likewise, the controller 410 may make use of a voice synthesizer system (not shown) to convert a textual translation into an audio translation. These alternate format translations may also be stored in the translation storage device 460.

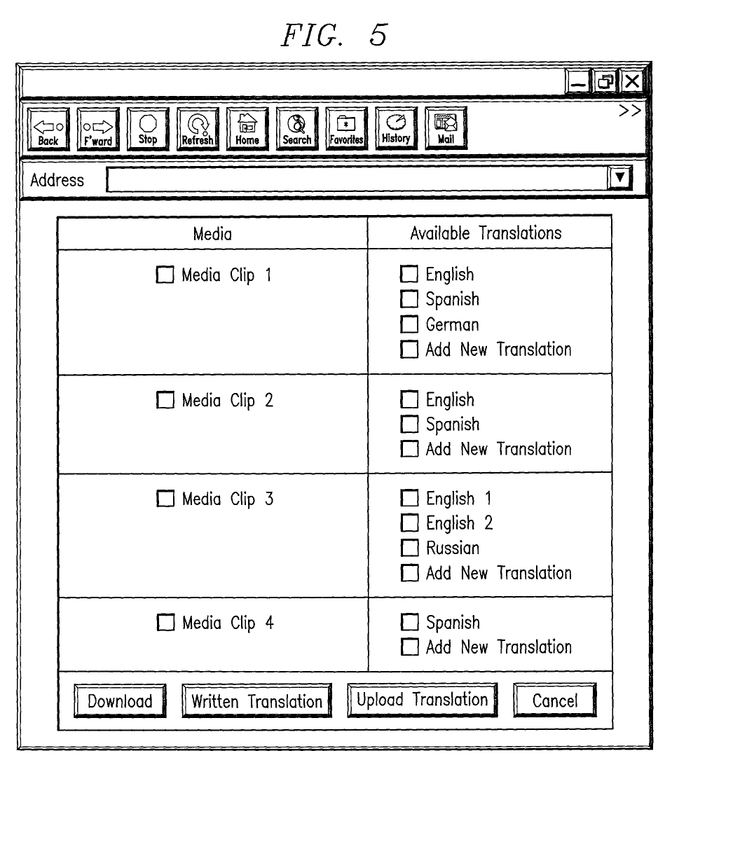

FIG. 5 is an exemplary diagram of an interface, such as a web page, applet display, or the like, that is downloaded to the client device in response to receiving a request for media. As shown in FIG. 5, the interface includes a listing of media and corresponding translations. In addition, there are selectable options for each of the media for submitting a new translation for the media. In addition, there are a plurality of virtual buttons that may be selected for initiating various functions including downloading media and a corresponding translation, downloading a written or textual translation, uploading a translation, or canceling the operation.

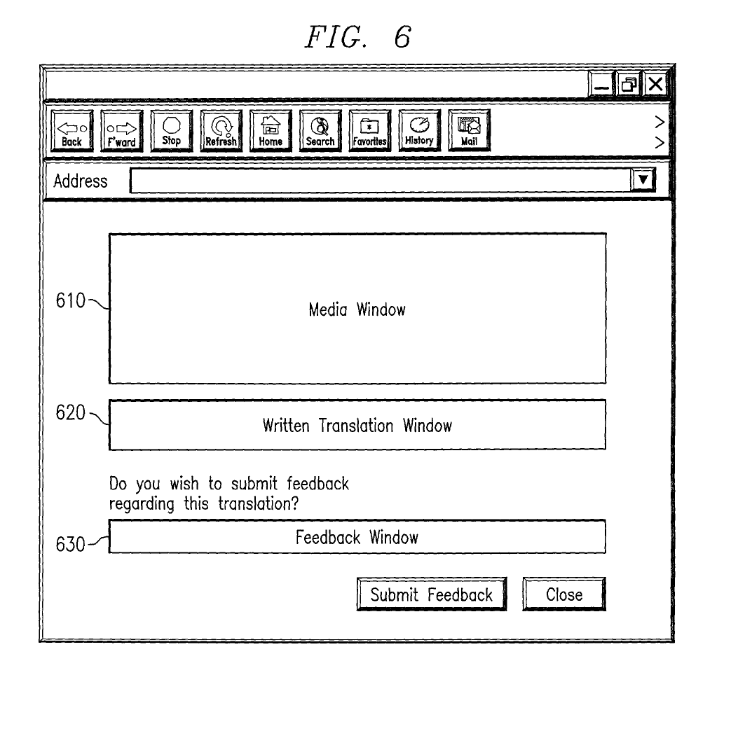

FIG. 6 is an exemplary diagram of an interface, such as a web page, applet display, or the like, that is provided to a client device when providing a selected media and a corresponding translation. As shown in FIG. 6, the interface includes a media window 610 for displaying the selected media. A written translation window 620 is provided for displaying a textual translation of the media. The written translation window 620 may only be provided if the user requested a written translation using the interface of FIG. 5. Rather than, or in addition to, providing a textual translation, the present invention may provide an audio translation via an audio output device (not shown) associated with the user's client device.

In addition to the above, the interface in FIG. 6 includes a feedback window 630 in which a user may provide feedback regarding the quality of the translation. Such feedback may be freeform or may be fixed form, as previously mentioned. The interface may further include virtual buttons for initiating the submission of the feedback and for closing the interface. In other embodiments, feedback may be requested via a form at the end of the media display, or solicited for submission via an e-mail.

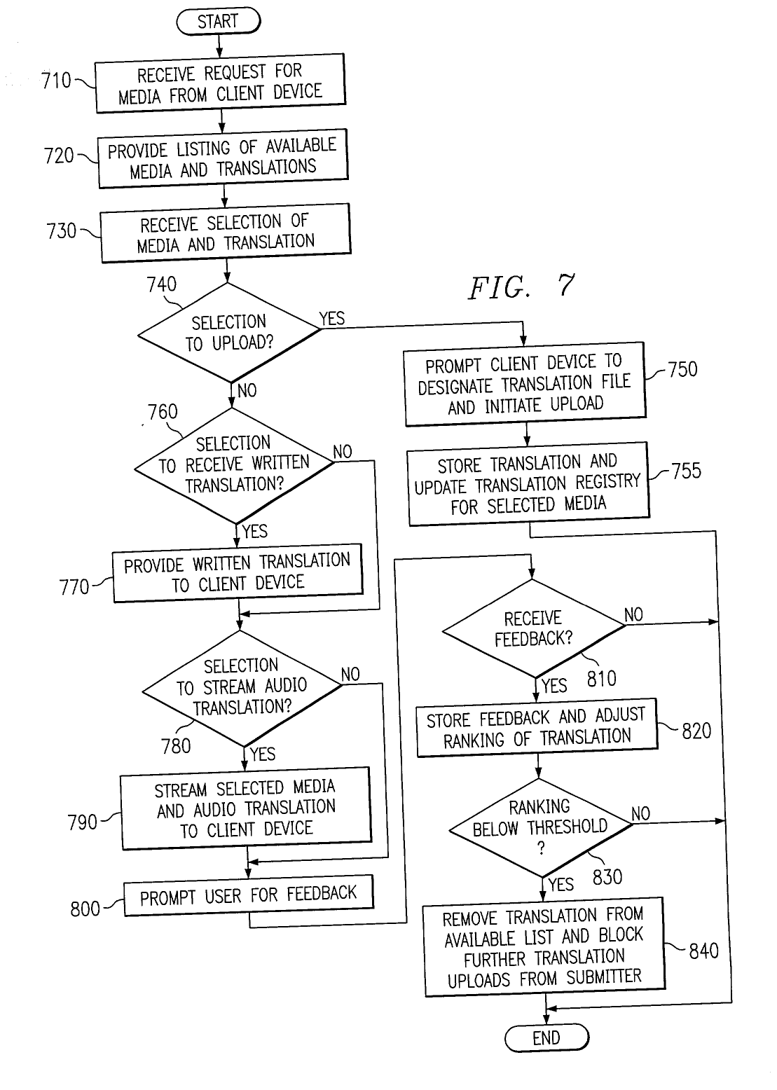

FIG. 7 is a flowchart outlining an exemplary operation of the present invention. As shown in FIG. 7, the operation starts with receipt of a request for media (step 710). In response to receiving the request, a listing of available media and corresponding translations is provided (step 720). Thereafter, a selection of media and a translation is received (step 730).

A determination is made as to whether the selection includes a selection to upload a translation (step 740). If so, the client device is prompted to designate the translation file and initiate the upload (step 750). Alternatively, the media may be streamed to the client device and the translation uploaded in realtime as described above. The media may be downloaded, and the translation may be streamed. Thereafter, the translation is stored and the translation registry is updated (step 755). Optionally, the translation may be reviewed by a third party in an editing step before being entered into the translation registry. Just as there are monitored and unmonitored online chats and forums, there may be monitored and unmonitored translations. Monitoring may be desired to ensure that offensive translations are not broadcast for example.

Thereafter, or if the selection does not include an upload selection, a determination is made as to whether the selection includes a request for a written translation (step 760). If so, the written translation is provided to the client device (step 770). The written translation may be superimposed on the media, as in closed captioning. This may be done while downloading the media to the client device or may be done separate from the downloading of the media to the client device. For example, the written translation may be downloaded to the client device as a text file that the user may open using a word processor or other document editor application.

Thereafter, or if the selection does not include a request for a written translation, a determination is made as to whether the selection requested an audio translation (step 780). If so, the media and the audio translation are streamed to the client device (step 790). As mentioned previously, this may involve sending multiple data streams or a single data stream in which the translation is added to the tracks of the media and remixed. If the selection did not include a request for audio translation, the operation ends.

After providing the media and translation to the client device, the user is prompted to provide feedback (step 800). A determination is then made as to whether feedback is received from the user (step 810). If so, the feedback is stored and the quality ranking of the translation is adjusted based on the feedback (step 820). A determination is then made as to whether the quality ranking for the translation is below a threshold (step 830). If not, or if feedback is not received, the operation ends. If the quality ranking is below the threshold, the translation is removed from the available translation listing and further translations from the submitter of the translation may be blocked (step 840).

Thus, the present invention provides a mechanism by which users may upload translations for use by other users in an open source manner. Quality of the translations is maintained by allowing users to provide feedback that directly affects the quality ranking of the translation and provides a measure of whether the translation should be made available to other users. Moreover, the present invention provides a mechanism by which suppliers of translations may be paid based on the number of times their translations are downloaded. Other payment schemes for the translator include flat fee, fee based on minutes of translation, number of words, number of scenes, importance of media, time critical nature of media, rarity of the translation skills, and the like.

While the preferred embodiments of the present invention has been described in terms of providing only translations of media, the present invention is not limited to such. Rather, any interpretation, commentary, or the like, may be provided in the same manner as described above. In this way, the “translation” may include a commentary on the media, similar to director commentaries on special edition DVDs and the like, humorous commentaries, such as humorous voices on a cartoon media, humorous comments, similar to Mystery Science Theatre 2000™, or the like.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of providing media interpretations, comprising:
receiving an interpretation of a portion of media from a source device;
storing the interpretation in association with the portion of media; and
updating a registry of interpretations for the portion of media to include the received interpretation, wherein the registry identifies interpretations that are made available for download to client devices.

2. The method of claim 1, wherein the interpretation is a translation of the media in a different language from a language in which the media is presented to the source device.

3. The method of claim 1, wherein the interpretation is a written interpretation.

4. The method of claim 1, further comprising:
providing the portion of media and the interpretation to a client device.

5. The method of claim 4, wherein providing the portion of media and the interpretation to the client device includes streaming the portion of media to the client device in a first data stream and streaming the interpretation to the client device in a second data stream.

6. The method of claim 5, wherein the first data stream and the second data stream are correlated using markers present in the first data stream and the second data stream.

7. The method of claim 6, wherein the markers are timestamps.

8. The method of claim 1, wherein storing the interpretation in association with the portion of media includes modifying a track in the portion of media using the interpretation and remixing the portion of media.

9. The method of claim 8, further comprising providing the portion of media and the interpretation to a client device as a single data stream.

10. The method of claim 1, wherein receiving the interpretation of the portion of media from the source device includes receiving the interpretation as a complete data file.

11. The method of claim 1, wherein receiving the interpretation of the portion of media from the open source device includes receiving the interpretation in real time as the portion of media is streamed to the source device.

12. The method of claim 1, further comprising compiling information regarding a user of the source device.

13. The method of claim 12, wherein the information includes one or more of a user name, a user address, a user electronic mail address, a translator identification, a user education level, a level of expertise in a language of the interpretation, a description of the interpretation, and a parental guidance rating of the interpretation.

14. The method of claim 1, further comprising recording a number of times the interpretation is provided to client devices.

15. The method of claim 14, further comprising compensating a user of the source device based on the number of times the interpretation is provided to client devices.

16. The method of claim 1, further comprising compensating a user of the source device for providing the interpretation.

17. The method of claim 16, wherein compensating the user includes providing payment to the user based on at least one of a flat fee payment scheme, a length of the portion of media payment scheme, an importance of the portion of media payment scheme, and a bounty payment scheme.

18. The method of claim 1, further comprising authenticating a user of the source device, wherein the steps of receiving the interpretation, storing the interpretation, and updating the registry are performed only if the user is an authorized user.

19. The method of claim 1, further comprising generating an alternate version of the interpretation by converting a format of the interpretation to another format.

20. The method of claim 19, wherein the format of the interpretation is one of audio and text and wherein the another format is the other of audio and text.

21. The method of claim 4, further comprising receiving feedback from a user of the client device.

22. The method of claim 21, further comprising updating a ranking of the interpretation based on the feedback received from the user of the client device.

23. The method of claim 22, further comprising:
determining if the ranking of the interpretation is below a predetermined threshold; and
updating the registry if the ranking of the interpretation is below the predetermined threshold.

24. The method of claim 23, wherein updating the registry includes removing the interpretation from the registry.

25. An apparatus for providing media interpretations, comprising:
an interface through which an interpretation of a portion of media is received from a source device;
a storage device which stores the interpretation in association with the portion of media; and
a controller that updates a registry of interpretations for the portion of media to include the received interpretation, wherein the registry identifies interpretations that are made available for download to client devices.

26. The apparatus of claim 25, wherein the interpretation is a translation of the media in a different language from a language in which the media is presented to the source device.

27. The apparatus of claim 25, wherein the interpretation is a written interpretation.

28. The apparatus of claim 25, wherein the controller provides the portion of media and the interpretation to a client device.

29. The apparatus of claim 28, wherein the controller provides the portion of media and the interpretation to the client device by streaming the portion of media to the client device in a first data stream and streaming the interpretation to the client device in a second data stream.

30. The apparatus of claim 29, wherein the first data stream and the second data stream are correlated using markers present in the first data stream and the second data stream.

31. The apparatus of claim 30, wherein the markers are timestamps.

32. The apparatus of claim 25, wherein the storage device stores the interpretation in association with the portion of media by modifying a track in the portion of media using the interpretation and remixing the portion of media.

33. The apparatus of claim 32, wherein the controller provides the portion of media and the interpretation to a client device as a single data stream.

34. The apparatus of claim 25, wherein the interface receives the interpretation of the portion of media from the source device as a complete data file.

35. The apparatus of claim 25, wherein the interface receives the interpretation of the portion of media from the source device in real time as the portion of media is streamed to the source device.

36. The apparatus of claim 25, wherein the controller compiles information regarding a user of the source device.

37. The apparatus of claim 36, wherein the information includes one or more of a user name, a user address, a user electronic mail address, a translator identification, a user education level, a level of expertise in a language of the interpretation, a description of the interpretation, and a parental guidance rating of the interpretation.

38. The apparatus of claim 25, wherein the controller records a number of times the interpretation is provided to client devices.

39. The apparatus of claim 38, further comprising a payment system that compensates a user of the source device based on the number of times the interpretation is provided to client devices.

40. The apparatus of claim 25, further comprising a payment system that compensates a user of the source device for providing the interpretation.

41. The apparatus of claim 40, wherein the payment system compensates the user by providing payment to the user based on at least one of a flat fee payment scheme, a length of the portion of media payment scheme, an importance of the portion of media payment scheme, and a bounty payment scheme.

42. The apparatus of claim 25, wherein the controller authenticates a user of the source device, wherein the interface receives the interpretation, the storage device stores the interpretation, and the controller updates the registry only if the user is an authorized user.

43. The apparatus of claim 25, wherein the controller generates an alternate version of the interpretation by converting a format of the interpretation to another format.

44. The apparatus of claim 43, wherein the format of the interpretation is one of audio and text and wherein the another format is the other of audio and text.

45. The apparatus of claim 28, wherein the interface receives feedback from a user of the client device.

46. The apparatus of claim 45, wherein the controller updates a ranking of the interpretation based on the feedback received from the user of the client device.

47. The apparatus of claim 46, wherein the controller determines if the ranking of the interpretation is below a predetermined threshold and updates the registry if the ranking of the interpretation is below the predetermined threshold.

48. The apparatus of claim 47, wherein the controller updates the registry by removing the interpretation from the registry.

49. A computer program product in a computer readable medium for providing media interpretations, comprising:
first instructions for receiving an interpretation of a portion of media from a source device;
second instructions for storing the interpretation in association with the portion of media; and
third instructions for updating a registry of interpretations for the portion of media to include the received interpretation, wherein the registry identifies interpretations that are made available for download to client devices.

50. A system for providing media interpretations, comprising:
means for receiving an interpretation of a portion of media from a source device;
means for storing the interpretation in association with the portion of media; and
means for updating a registry of interpretations for the portion of media to include the received interpretation, wherein the registry identifies interpretations that are made available for download to client devices.
